(19) United States
(12) Patent Application Publication
(10) Pub. No.: US 2002/0101846 A1
(43) Pub. Date: Aug. 1, 2002

(54) METHOD FOR ADAPTING A RECEIVER TO TRANSMISSION CONDITIONS AND A CORRESPONDING RECEIVER

(76) Inventors: CHRISTIAN ERBEN, ECHING (DE); OTMAR RINGELHAAN, GREIFENBERG (DE)

Correspondence Address: Lerner & Greenberg PA, Post Office Box 2480, Hollywood, FL, 33022-2480, US

(21) Appl. No.: 09/277,787

(22) Filed: Mar. 29, 1999

Related U.S. Application Data
(63) Continuation of application No. PCT/DE97/01909, filed on Sep. 1, 1997.
(63) Continuation of application No. 09/529,097, filed on Apr. 7, 2000.
Application No. 09/529,097 is a 371 of international application No. PCT/JP98/04541, filed on Oct. 7, 1998.

(30) Foreign Application Priority Data
Sep. 27, 1996 (DE) 196-39-887.8
Oct. 9, 1997 (JP) 9-277787
Jun. 25, 1998 (JP) 10-179096

(51) Int. Cl. H04B 1/38

(52) U.S. Cl. 370/345; 455/574; 455/68

(57) ABSTRACT

A TDMA receiver, e.g. mobile radio, is configured to be adaptable to transmission conditions. A redundantly coded message [lacuna] which is contained in a plurality of bursts of a frame sequence is received by the receiver. Essential functional groups of the receiver are disconnected from the power supply after the decoding of information of a message block and before the next message block arrives. Only a specific number of bursts is decoded, but, in the event of unsuccessful decoding, the system is switched over to decoding a larger number of the bursts.

### CROSS-REFERENCE TO RELATED APPLICATION

This is a continuation of copending International Application PCT/DE97/01909, filed Sep. 1, 1997, which designated the United States.

### BACKGROUND OF THE INVENTION

1. Field of the Invention

The invention relates to a method for adapting the function of a receiver, such as a pager or mobile radio, operated in a TDMA system, to the transmission conditions. A redundantly coded message is used which is contained as a message block in each case in bursts of n frames of a message frame sequence, in which method essential functional groups of the receiver are disconnected from the power supply in the time period after the decoding of information of a message block and before the next message block arrives.

The invention also relates to a receiver with an RF reception block, a reception logic block, a control block and a power supply, for example a mobile radio, a pager or the like. The reception logic block is set to process and decode TDMA signals, and the logic and control block is set to disconnect essential functional groups of the receiver from the power supply after the reception and decoding of a message and before the next message arrives.

In receivers and mobile radios which are independent of networks, for example those operating according to the GSM standard, particular value is placed on low power consumption in order to ensure the longest possible operation, in particular standby operation with a battery or an accumulator charge. Therefore, efforts are made to disconnect functional groups which are not required from the power supply for as long as possible in order to reduce the average power consumption.

In equipment which operates in a radio network with time-division multiplex organization, there is a standby mode [lacuna] for example all the functional groups which are not required can be periodically disconnected from the power supply in order to reduce the average power requirement.

The transmission technology of modern mobile radio networks, for example of the GSM network, uses highly redundant codes in order to reduce the influence of faults, in particular co-channel interference, and in order thus to increase the traffic performance of a system with otherwise fixed specifications such as frequency range, number of base stations, transmission power etc. The data processing, in particular the decoding in order to recover the original message, requires, however, a considerable computational complexity which in turn entails high power consumption.

On the other hand, the equipment and the codes which are used are conceived for the predefined, worst possible case of the transmission conditions, which in practice apply only occasionally so that it appears uneconomic to operate the equipment continuously with their full computational complexity for data processing/decoding.

Based on this knowledge, attempts have been made, for example, when operating a mobile radio with an equalizer operating according to a Viterbi algorithm, to match the number of states of the algorithm flexibly to the actually measured duration of multi-path interference, such as is described in Published, European Patent Application EP 496 152 A2 (Roke Manor Research Ltd.).

### SUMMARY OF THE INVENTION

It is accordingly an object of the invention to provide a method for adapting a receiver to transmission conditions and a corresponding receiver that overcome the above-mentioned disadvantages of the prior art methods and devices of this general type, which makes it possible to reduce the average computational complexity, and thus the power requirement, by matching the actually decoded frames and bursts to the transmission conditions, or in more precise terms to the reception conditions.

With the foregoing and other objects in view there is provided, in accordance with the invention, an improved method for adapting a function of a receiver to transmission conditions, the improvement which includes: a) decoding only a first portion of a plurality of bursts of a redundantly coded message transmitted as a message block by the plurality of bursts in time slots; b) disconnecting essential functional groups of the receiver from a power supply after the decoding of the first portion of the plurality of bursts; and c) determining a number of the plurality of bursts to be decoded in dependence on results of the decoding step a).

The object is achieved on the basis of a method of the type mentioned at the beginning by virtue of the fact that only a minimum number of bursts of the message in accordance with the redundancy of the coding used is decoded and the functional groups are switched off after this for as long as the decoding supplies the required message, but in the event of unsuccessful decoding the system is switched over to decoding a larger number of bursts.

The invention thus exploits the fact that the full redundancy of the code used is not required at all over large time periods, and exploits this fact to save energy, as a result of which a longer standby mode is obtained.

It is advantageous here if, after the reception and the evaluation of the minimum required number of bursts of a message block, in the case of unsuccessful decoding the frame or burst which is received immediately after the decoding is evaluated and subsequently in the event of overall successful decoding the functional block is switched off, and in the event of unsuccessful decoding the next frame or burst is evaluated, and so on.

On the other hand, with the method according to the invention in which whenever there is successful decoding of a message block a counter reading is increased by a specific value but whenever there is unsuccessful decoding it is decreased by another specific value and the counter reading is able to assume only a predefined maximum value. It may also be expedient if preferably only a portion of the bursts is used for decoding but in the event of incorrect decoding, e.g. reduction of the counter reading, all the bursts are decoded until the counter reading has increased to a predefined value which is smaller than or equal to the predefined maximum value. In one preferred variant, the information in the message block is coded by a fire code and a convolution code.

In many cases it may also be expedient if, in the event of unsuccessful decoding of the message block by the fire decoder, a reassessment of a limited number of the probably most unreliable bits of the input signals is carried out upstream of the convolution decoding unit, and the decoding process is repeated with the resulting combinations until the decoding is successful or all the combinations have been run through.

The invention can also be used to considerable advantage in cases in which the message is an item of paging information and the method is carried out in a paging mode.

The aforementioned object is also achieved with a receiver such as specified above, in which, according to the invention, the decoding unit is set up to decode only a minimum necessary number of bursts of each message block according to the redundancy of the coding used, for as long as a control and test unit which is assigned to decoding determines that the decoding is successful and supplies the necessary message. The control and test unit disconnecting the functional groups from the power supply after decoding, and the control and test unit causing the decoding unit to decode a larger number of message bursts if the decoding of the minimum number of bursts was not able to supply the message.

In such a receiver, that may be, for example, the reception part of a mobile radio or a so-called pager, the same advantages are obtained as those specified in conjunction with the method.

The decoding unit and the control and test unit are advantageously set, after the reception and the evaluation of the minimum necessary number of bursts of each message block, in the case of unsuccessful decoding, to evaluate the frame or burst which is received directly after the unsuccessful decoding.

One expedient development of the receiver according to the invention is defined by the fact that the control and test unit which is assigned to the decoding unit as a counter whose counter reading increases by a specific value in the event of each unsuccessful decoding of a message block, but decreases by another specific value in the event of unsuccessful decoding. In addition, a maximum value of the counter reading is predefined, and preferably only a minimum number of bursts of each message block are decoded, but in the event of incorrect coding, i.e. in the event of a reduction in the counter reading, all the bursts of each message frame are decoded until the counter reading has increased to a predefined value which is smaller than or equal to the predefined maximum value.

In one preferred variant, the information of the message block is available in a form that is coded by a fire code and a convolution code.

One further way of reducing the power consumption can be achieved in many cases if the logic reception block has a manipulator which is set to change a limited number of the probably most unreliable bits of the input signals upstream of the convolution decoding unit. The decoding unit is set to repeat the decoding process with the resulting combinations until the decoding is successful or all the combinations are run through.

Particular advantages of the invention are obtained if the message is an item of paging information and the logic and control block (LSB) is set, in a paging mode, to switch off the essential functional groups between the items of paging information.

Other features which are considered as characteristic for the invention are set forth in the appended claims.

Although the invention is illustrated and described herein as embodied in a method for adapting a receiver to transmission conditions and a corresponding receiver, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1a to 1c are diagrammatic signal profiles in a GSM system from one paging call to the next;

FIG. 2 is a block circuit diagram of a receiver according to the invention; and

FIG. 3 is a block circuit diagram of a further embodiment of the invention.

### DESCRIPTION OF THE PREFERRED EMBODIMENTS

The invention is explained in more detail below with particular reference to a mobile radio network in a global system for mobile communications (GSM system). The GSM system operates with a time division multiple access (TDMA) frame structure, which is described in more detail, for example, in “Mobile Radio Communications”, Raymond Steele, IEEE Press, New York. This reference is hereby incorporated by reference, in conjunction with the disclosure of the application, to this document and to other documents mentioned herein. The coding and interleaving of channels is also described in “GSM Recommendations, Draft prETS 300 575, Mar. 1995 (GSM 0.5 03 Version 4.2.0) and is incorporated by reference herein. With respect to the theory of fire codes and other codes reference is made to the books “Prüfbare und korrigierbare Codes [Testable and Correctable Codes]” W. Wesley Peterson, R. Oldenburg Verlag [Publishing house] 1967 and “Wireless Digital Communications, Modulation and Spread Spectrum Applications”, Dr. Kamilo Feher, Prentice-Hall PTR incorporated by reference herein.

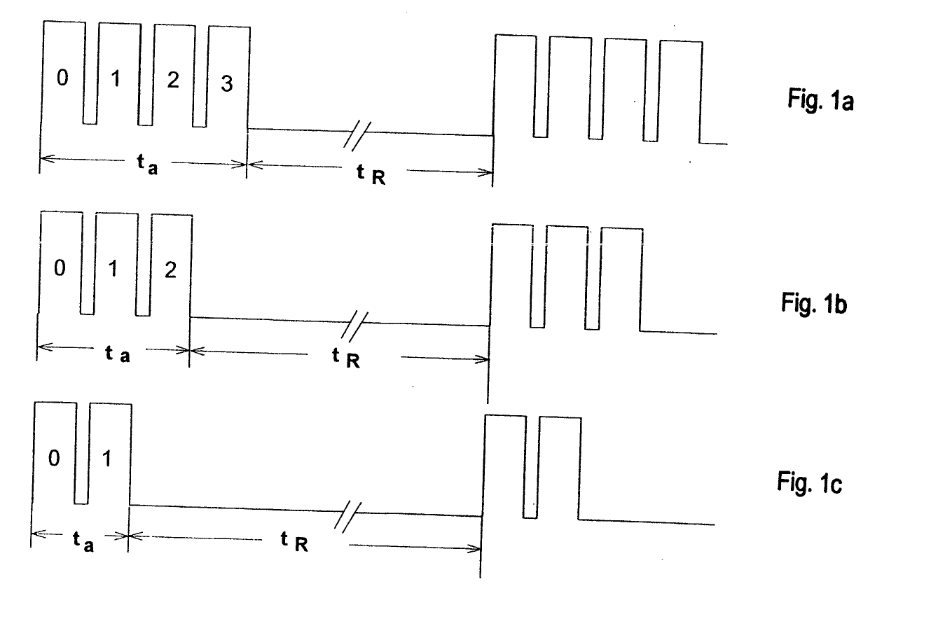

In all the figures of the drawing, sub-features and integral parts that correspond to one another bear the same reference symbol in each case. Referring now to the figures of the drawing in detail and first, particularly, to FIG. 1a thereof, there is shown the so-called “standby mode” in which the receiver is ready for operation and is of interest for the present invention. As is clear from FIG. 1a, the receiver of a GSM mobile radio receives, periodically during an active time tₐ, four TDMA frames 0, 1, 2, 3 of 4.6 ms duration each. The frames 0-3, for example, each contained in a burst “0” of paging information which is part of the “control channels”. In the time after this, designated by t_{R} as “idle time”, there is, depending on the system, 102 to 459 TDMA frames, which corresponds to a time period of approximately 0.5 to 2.1 s. During this time, essential functional groups of the equipment can be switched off, in accordance with the prior art.

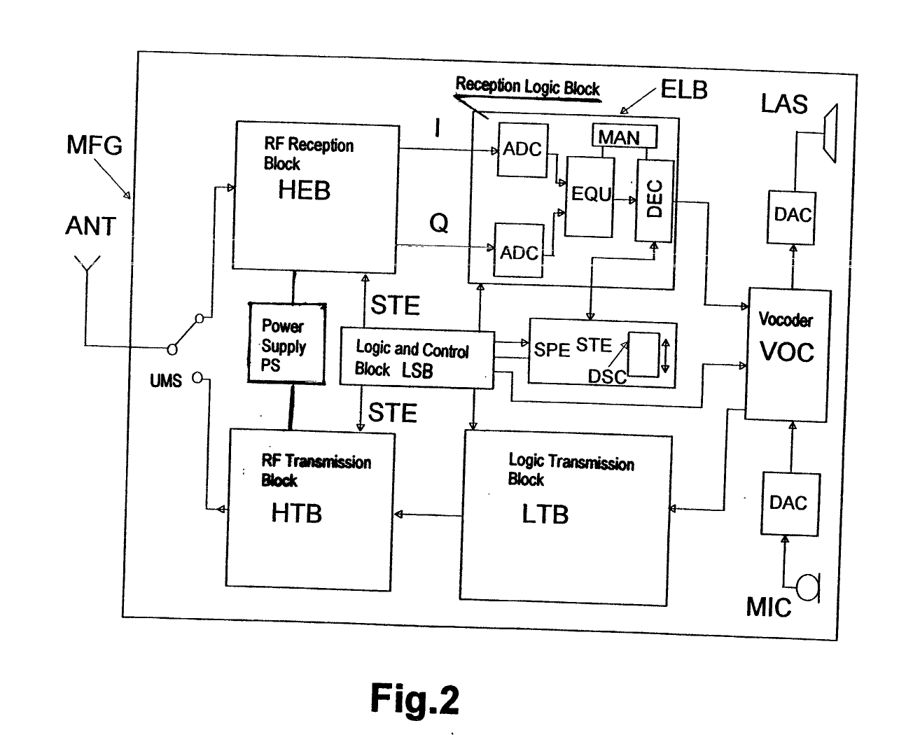

The block circuit diagram according to FIG. 2 shows a schematic view of a mobile radio MFG which has essentially an RF reception block HEB, a reception logic block ELB, an RF transmission block HTB, a logic transmission block LTB, a logic and control block LSB and a vocoder VOC. The RF transmission block HTB and the RF reception block HEB are connected to an antenna ANT via a change-over switch UMS. Connected to the vocoder VOC are a digital/analog converter DAC or an analog/digital converter ADC, and a microphone MIC or a loudspeaker LAS. A more detailed view of the configuration of the mobile radio MFG is not given wherever it does not relate to the invention.

The reception logic block ELB has in each case one analog/digital converter ADC for signals I, Q which arrive from the RF reception block HEB. The converters ADC are followed by an equalizer EQU and a decoder DEC. Assigned to the decoder DEC is a control and test unit SPE with a counter DSC which is designated in the GSM system as a “downlink signaling failure counter”. In addition, the logic reception block ELB also contains a manipulator MAN that will be described later.

The logic and control block LSB has, inter alia, the function of disconnecting from a power supply PS (i.e. battery, accumulator) all of the functional groups or components which are not required, for example using control signals STE. Of course, the logic and control block LSB receives information that is suitable for this from the various blocks. The sequence and functioning of the method and of the receiver in accordance with the invention will be explained in more detail below.

In a control channel in the GSM system that is under consideration by way of example, blocks are used which have a fixed size of 184 bits. In order to detect and correct faults, the bits are protected in accordance with a fire code with 40 parity bits, and four so-called “tail bits” are subsequently added on. The block having 228 bits is then coded according to an unsystematic convolution code with the rate ½, so that ultimately a frame with 456 coded bits is produced.

For transmission, such a frame is then distributed, according to a predefined pattern, between, for example, four or eight bursts that are then transmitted with other bursts (from other channels) in a time-division multiplex mode.

At the reception end, usually all the bursts associated with a frame are evaluated and used to reconstruct the message. To do this, it is necessary, in a way analogous to the transmission side, to reassemble the signals from the individual bursts to form a frame again. In the decoder DEC, or more precisely in a first decoding unit of the decoder DEC, the redundancy of the convolution code is initially removed from the frame. Since the code is unsystematic, the result bits do not have any correspondence in the transmitted signal. In order to determine a specific bit, instead the entire associated vicinity of the signal, or more precisely the complete received frame, is examined and evaluated. A result bit can thus also be evaluated if the vicinity of the signal is thinned out to a certain degree as a result of bursts that are not evaluated. In the present example, the limit of evaluation is reached for example if only half of the bursts that are associated with a frame is evaluated.

The bits which are determined according to this decoding are also subject to the redundancy of the fire code, i.e. they are appropriately decoded in accordance with the fire code in a second decoding unit of the decoder DEC. The decoding unit or the decoder DEC decides between “evaluation” and “rejection”, and the rejection rate can also be used to determine the respectively necessary number of bursts to be evaluated, in order to reduce the average power consumption by reducing the evaluation time. The control and test unit SPE is then set to increase the reading of the counter DSC by a specific value, for example by one, in the event of successful decoding of a burst of the paging information, but to decrease this reading by another specific value, for example by four, in the event of unsuccessful decoding, for example in the case of “rejection”. If the value zero is reached, a cell change occurs, i.e. another radio cell is sought.

If the predefined limit value or another predefined value of the counter DSC is reached, it is possible to attempt to reduce the degree of thinning out of the processing/decoding. FIG. 1b shows the case in which only the first three TDMA frames 0, 1, 2 are processed, most of the functional groups being disconnected from the power supply PS after the third frame by the logic and control block LSB. The active time tₐ (with a high power requirement) is reduced and the idle time t_{R} (with a low power requirement) is lengthened. If, as is shown in FIG. 1c, two TDMA frames, here the frames 2, 3, are omitted from a total of four frames in each case, a further lengthening of the idle time t_{R} is obtained.

In one embodiment of the invention, for example only the first two TDMA frames 0, 1 are thus evaluated and decoded in each case when, or for as long as, the counter reading of the counter is at its maximum value. As long as the decoding in this way is successful, which requires correspondingly favorable reception conditions, the (maximum) counter reading will not change in any way. However, in the event of unsuccessful decoding the counter reading is reduced and the control and test unit SPE then causes all the received TDMA frames of the paging information to be processed, specifically until the maximum counter reading is reached again. Here, there may be a time specification to the effect that, for the sake of safety, all, in this case four, TDMA frames of the paging information are then processed for a specific time before it is attempted to return to the processing/decoding of a smaller number.

One variant of the invention provides that, after reception and evaluation of a specific minimum number of frames or bursts of a paging block, in this case for example two frames 0, 1, the directly following frame, in this case the frame 2, is evaluated and decoded only if the decoding of the preceding frames did not produce any success. If the decoding of the first two frames was expedient owing to good reception conditions, the evaluation of further frames is dispensed with. Thus, in each case only as many frames or bursts are periodically decoded as are currently necessary, which of course requires the signal processing and the following decision to take place very quickly.

A further refinement of the invention relates to the manipulation of the primary signals, i.e. the signals before the decoding of the convolution code, for which the bit manipulator MAN is provided. If only half of the bursts (frames) are evaluated, the remaining redundancy, and thus the euclidic distance between (valid) code words which is relevant in this context is relatively small, it is still possible, in the event of a rejection by a fire decoder FIR, to attempt to bring about another decoding result which is acceptable for the fire decoder FIR, by selective manipulation of the primary signals.

Any item of channel information that indicates the probability with which a primary bit is a zero or a one can be useful for this. The bit manipulator MAN then changes a limited number of those bits which are unreliable with a high degree of probability, and, using the changed bits, the decoding process is repeated with new combinations again and again until the fire decoder FIR has been successful or all the predefined combinations have been run through.

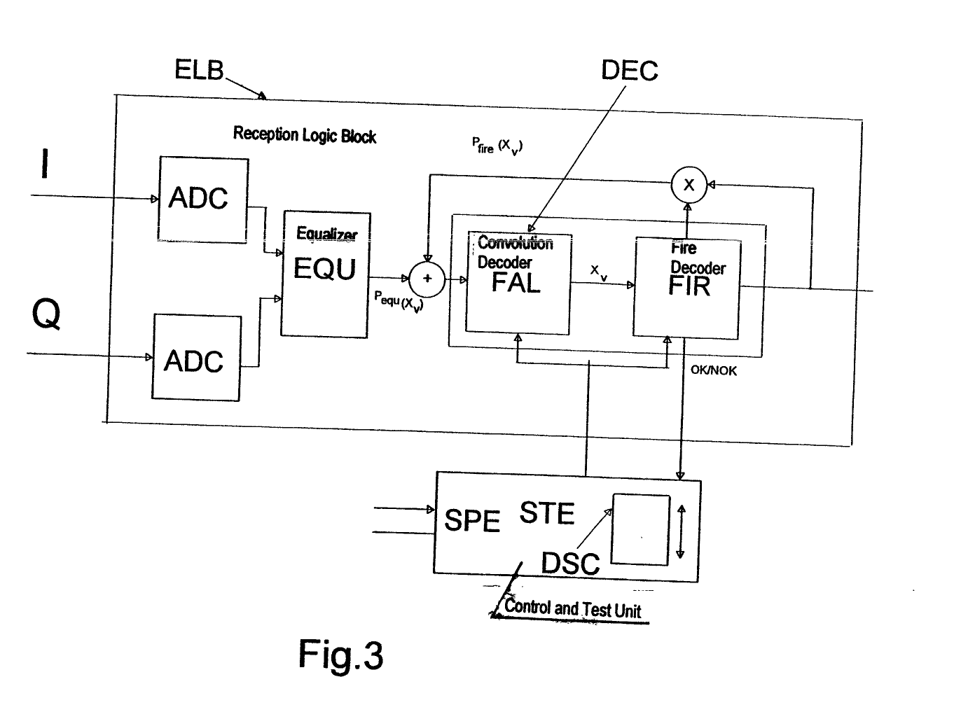

For further explanation, refer to FIG. 3 that shows an implementation of the invention in greater detail.

The equalizer EQU supplies the received bursts in the form of a bit stream P_{equ} (Xᵥ) with inherent reliability information for each bit to the decoder DEC which contains the convolution decoder FAL and the fire decoder FIR. At the first decoding run, there is still no information from the fire decoder output available, i.e. P_{fire} (Xᵥ)=0. After the convolution decoding, the decoded bit stream Xᵥ, which no longer contains any reliability information, is passed onto the fire decoder FIR.

If the result of the decoding process is not satisfactory, a signal NOK is transmitted to the control and test unit STE, which could of course also be located within the decoder DEC, and the block-decoded bit stream, multiplied by the reliability information generated by the fire decoder FIR, can be fed back to the input of the convolution decoder FAL. The latter then starts the decoding process once more with the values P_{equ} (V) of the equalizer EQU, supplemented with the reliability information P_{fire} (Xᵥ) of the fire decoder FIR, which information is then different from zero. It is the process that is symbolically attributed to the manipulator MAN in FIG. 2.

The invention is described above in conjunction with the reception component of a mobile radio, but it must be clear that it can also be applied in conjunction with other reception devices that operate in a TDMA system with a correspondingly redundant code. For example, this may be a pager receiver or else also digital, battery-operated radio or television receivers in which it is also desired to minimize the power consumption, i.e. the invention is not restricted to cases in which paging mode occurs, and the processing of information according to the invention can relate to any kind of message.

We claim:

1. An improved method for adapting a function of a receiver to transmission conditions, the improvement which comprises:
a) decoding only a first portion of a plurality of bursts of a redundantly coded message transmitted as a message block by the plurality of bursts in time slots;
b) disconnecting essential functional groups of the receiver from a power supply after the decoding of the first portion of the plurality of bursts; and
c) determining a number of the plurality of bursts to be decoded in dependence on results of the decoding step a).

2. The method according to claim 1, which comprises:
disconnecting the essential functional groups of the receiver from the power supply if a successful decoding of a minimum number of the plurality of bursts necessary according to a redundancy of the coding has occurred; and
decoding a lager number of the plurality of bursts in an event of unsuccessful decoding during step a).

3. The method according to claim 1, which comprises:
increasing a counter reading by a specific value whenever the message block is successfully decoded using only a portion of the plurality of bursts, the counter reading being able to assume only a predefined maximum value; and
decreasing the counter reading by another specific value whenever there is an unsuccessful decoding and decoding all of the plurality of bursts until the counter reading has increased to a predefined value which is smaller than or equal to the predefined maximum value.

4. The method according to claim 1, which comprises coding information of the message block by a fire code and a convolution code.

5. The method according to claim 4, which comprises:
reassessing a limited number of probably most unreliable bits of input signals is carried out upstream of a convolution decoding unit in an event of unsuccessful decoding of the message block by a fire decoder; and
repeating the decoding process with resulting combinations until the decoding is successful or all the resulting combinations have been run through.

6. The method according to claim 1, wherein the redundantly coded message is an item of paging information and the method is carried out in a paging mode.

7. A receiver, comprising:
a power supply supplying power to essential functional groups;
an RF reception block;
a reception logic block having a decoding unit and connected to said RF reception block, said reception logic block set to process and decode time slot signals;
a control and test unit connected to said decoding unit, said decoding unit set for decoding only a minimum necessary number of message bursts of each message block of a message according to a redundancy of coding used as long as said control and test unit determines that the decoding is successful and supplies necessary control messages, said control and test unit outputting disconnect signals for disconnecting the essential functional groups from said power supply after the decoding process, said control and test unit causing said decoding unit to decode a larger number of message bursts if the decoding of the minimum necessary number of message bursts was not able to supply the message; and
a logic and control block connected to said RF reception block and said reception logic block and set for disconnecting the essential functional groups from said power supply after reception and decoding of a message and before a next message being received.

8. The receiver according to claim 7, wherein after receiving and evaluating the minimum necessary number of message bursts of the message block, in a case of unsuccessful decoding said decoding unit and said control and test unit are set to evaluate one of a frame and a message burst received directly after the unsuccessful decoding.

9. The receiver according to claim 7, wherein said control and test unit has a counter with a counter reading increasing by a specific value for each successful decoding of the message block, said counter reading decreasing by another specific value in an event of an unsuccessful decoding, said counter having a predefined maximum value for said counter reading, and only the minimum necessary number of message bursts of the message block being decoded, but in an event of incorrect decoding all of the message bursts of each paging frame being decoded until said counter reading has increased to a predefined value which is smaller than or equal to the predefined maximum value.

10. The receiver according to claim 7, wherein said decoding unit is set to decode message block information that has been coded by a fire code and a convolution code.

11. The receiver according to claim 10, wherein said decoding unit has a fire decoding unit and a convolution decoding unit connected to said fire decoding unit, said reception logic block has a manipulator set to change a limited number of probably most unreliable bits of input signals upstream of said convolution decoding unit, and said decoding unit is set to repeat the decoding process with resulting combinations until the decoding is successful or all the resulting combinations have been run through.

12. The receiver according to claim 7, wherein the message is an item of paging information, and said logic and control block is set in a paging mode to switch off the essential functional groups between items of paging information.

13. The receiver according to claim 7, wherein the receiver is one of a mobile radio and a pager.
